(19) United States
(12) Patent Application Publication
(10) Pub. No.: US 2016/0238498 A1
(43) Pub. Date: Aug. 18, 2016

(54) IMPACT GENERATING EQUIPMENT FOR DYNAMIC LOADING TESTS

(71) Applicants: Marcos SILVA CARCELES, Sao Paulo (BR); Bruno GONÇALVES CARCELES, Sao Paulo (BR)

(72) Inventors: Marcos SILVA CARCELES, Sao Paulo (BR); Bruno GONÇALVES CARCELES, Sao Paulo (BR)

(21) Appl. No.: 14/710,663

(22) Filed: May 13, 2015

(30) Foreign Application Priority Data
Feb. 18, 2015 (BR) 10 2015 003467 9

(51) Int. Cl. G01N 3/02

(52) U.S. Cl. CPC G01N 3/02

(57) ABSTRACT

A new impact generating equipment for dynamic loading tests, designed to be adjustable to various sizes of structures and formats, particularly for piles of construction sites, so that the dynamic loading tests can be performed more easily, more efficiently and with faster speed, leading to results with minimum error margins in less time, and with a constructiveness that facilitates its transport and handling, generating logistic gains and reducing costs in the execution of tests.

### CROSS-REFERENCE TO RELATED APPLICATIONS

This application claims priority to Brazilian Application No. 10 2015 003467 9, having a filing date of Feb. 18, 2015, the entire contents of which are hereby incorporated by reference.

### FIELD OF TECHNOLOGY

The following refers to a new impact generating equipment for dynamic loading tests.

Said equipment was particularly designed to be adjustable to various sizes of structures and formats, particularly for piles of construction sites, so that the dynamic loading tests can be performed more easily, more efficiently and with faster speed, leading to results with minimum error margins in less time.

Said equipment is provided with a singular constructiveness which facilitates transport and handling, generating logistic gains and reducing costs in the execution of tests, allowing faster positioning at construction sites and faster adjustment of said equipment for the start of work.

Said equipment belongs particularly to the field of devices for measurement of the load capacity percentage in dynamic loading tests of foundations, and was designed to optimize its transport logistics and use, allowing the same equipment to execute tests on different types of piles, depending on their characteristics, being therefore a versatile equipment of great utility and practicability to the end to which it is intended.

### BACKGROUND

As widely known by professionals involved in the field of construction sites, the state of the art presents some models of equipment for dynamic loading tests, which have similar characteristics to each other, and which have, in general, the same structure.

A model of an impact generating equipment widely used by most of the companies running loading tests is provided with a control device for the positional configuration of the hammer, that is performed by a measuring ruler, so that this positioning is more accurate and the hammer applies defined strokes over the pile, starting from previously defined heights and aligned by the measurement ruler, so that the data captured by the impact of the hammer on the pile represent the actual capacity of the structure to be tested.

The equipment provided by the prior art collects and registers data of the hammer stroke over the pile in a database provided in a computer, and said equipment consists basically of a metal support structure made of metal profiles, this structure establishing a lower hollow field of greater dimension and extending superiorly so thin so that it becomes the hammer guide structure in whose ridge the vertical measuring ruler crosses, which has a hammer on its extreme lower part; said thin upper structure defined particularly by metal profiles with guides.

In addition to the above mentioned structure, this equipment also presents a head, an impact hammer, a measuring ruler provided with vertically aligned holes, and finally, a locking and releasing device of the ruler/hammer assembly which is complemented by a hydraulic pump, connecting hoses and sensors, and all this structure necessary for the execution of the dynamic loading test is positioned on the floor so that the aforementioned dynamic loading test can be executed.

In the case of said equipment for testing the dynamic loading on piles, each equipment, particularly each hammer, is dimensioned and shaped according to the structure of each pile to be tested, requiring the production of a hammer for each pile, in case they have different dimensions.

At construction sites with more than one type of pile, or with piles of different dimensions and shapes, specific hammers and structures are required for each of them, all burdening the process regarding the materials, and especially in relation to the transport logistics and accommodation of the equipment in said construction site.

Another frequent inconveniency concerns to eventual faults occurring on the upper contact face of the reinforcing block of the pile with the hammer

### SUMMARY

Thinking about these drawbacks and interested in providing a unique, versatile and efficient constructiveness, to favor the transport logistics and handling of the impact equipment, in addition to substantially minimize cost of the entire process necessary to test the piles at construction sites, the inventor created and developed this “IMPACT GENERATING EQUIPMENT FOR DYNAMIC LOADING TESTS” that should highlight from the existing equipment and personalize itself to all the engineering professionals involved in jobs of this nature, by the fact that it consists of an equipment which is adjustable to different sizes and formats of structures, particularly of piles, so as to obtain more appropriate logistics, with lower costs and shorter transport times, placement in operation and adjustment of the equipment for the start of work, said equipment designed, therefore, to optimize the transport logistics and the use of the impact generating equipment, allowing the same equipment to perform tests on different types of piles, depending on their characteristics.

### BRIEF DESCRIPTION

Some of the embodiments will be described in detail, with reference to the following figures, wherein like designations denote like members, wherein:

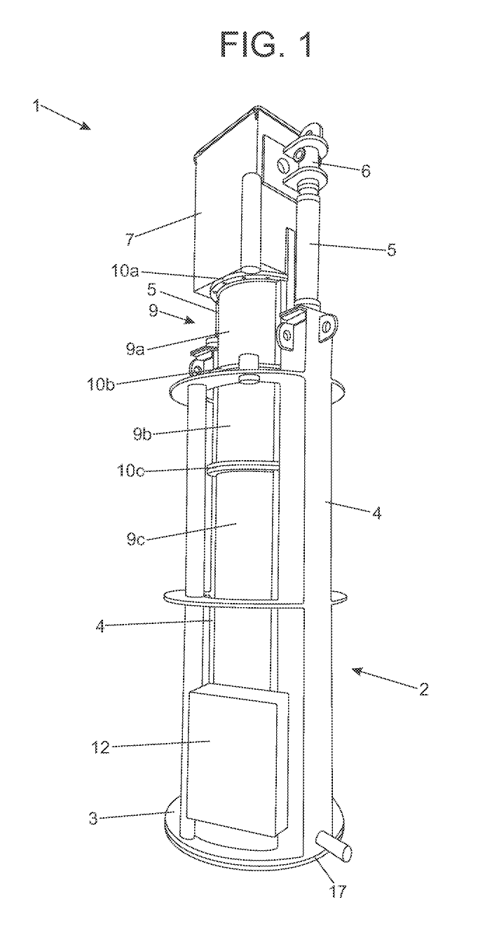

FIG. 1 shows a first perspective view of an embodiment of an impact generating equipment for dynamic loading tests;

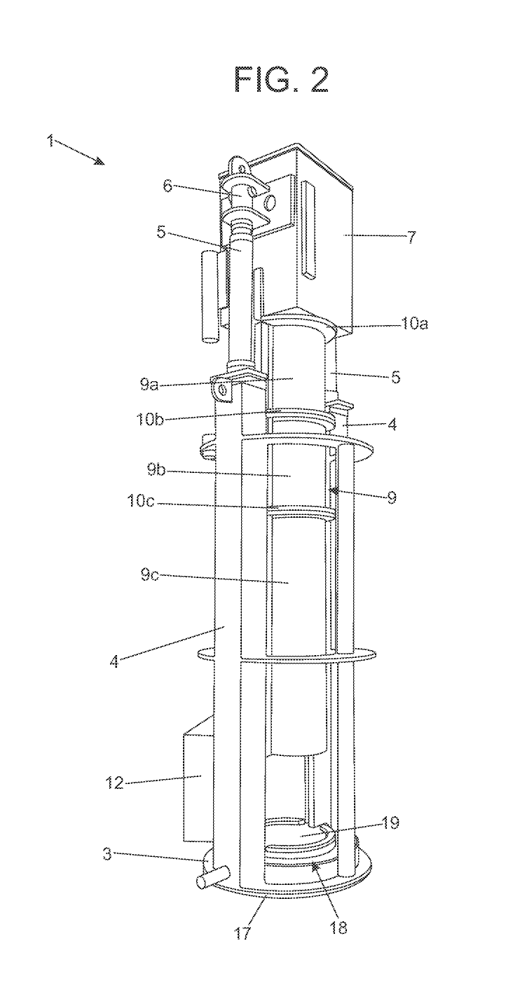

FIG. 2 shows a second perspective view of an embodiment of the impact generating equipment for dynamic loading tests;

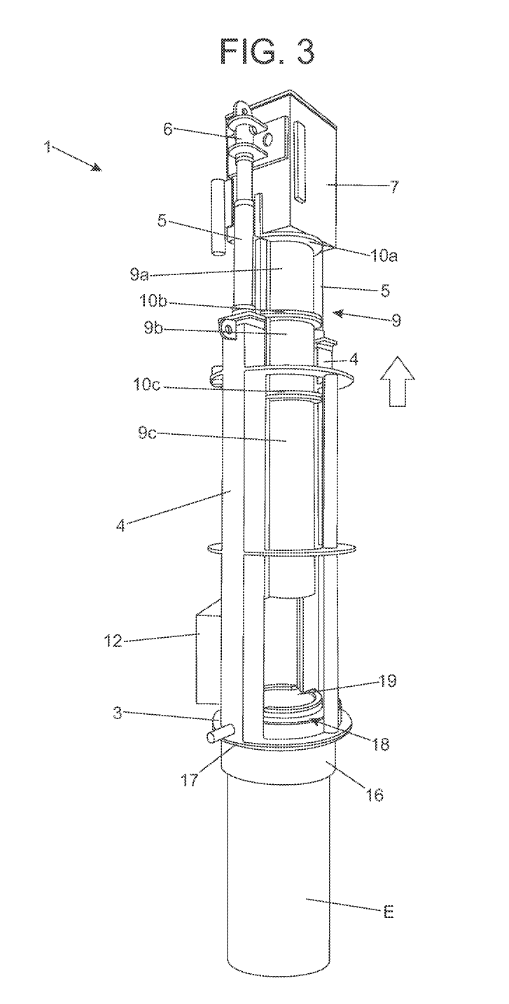

FIG. 3 shows a first perspective view of an embodiment of the impact generating equipment for dynamic loading tests being positioned on the reinforcing block of the pile;

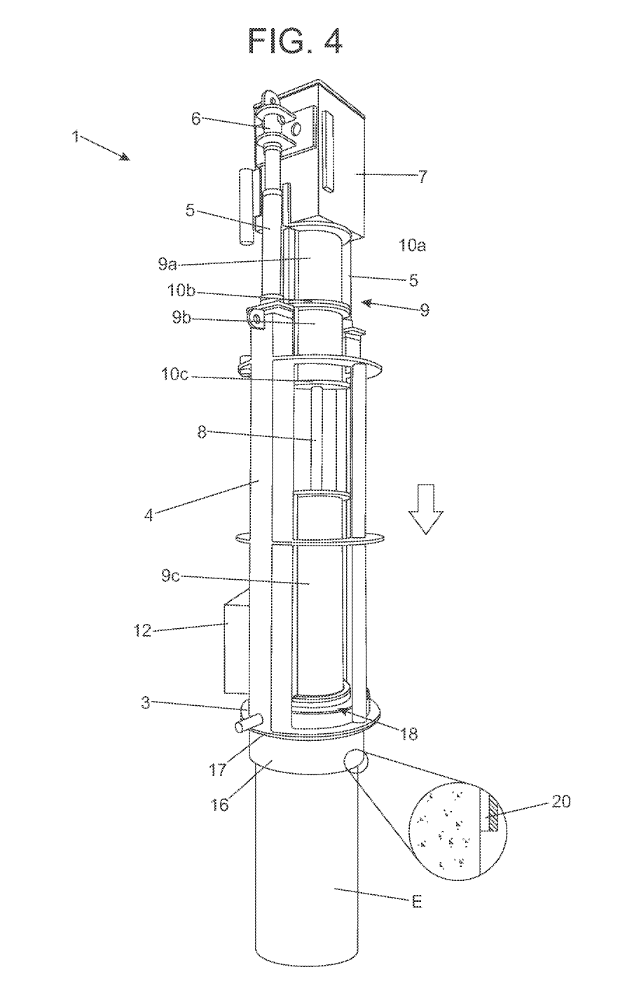

FIG. 4 shows a second perspective views of an embodiment of the impact generating equipment for dynamic loading tests being positioned on the reinforcing block of the pile;

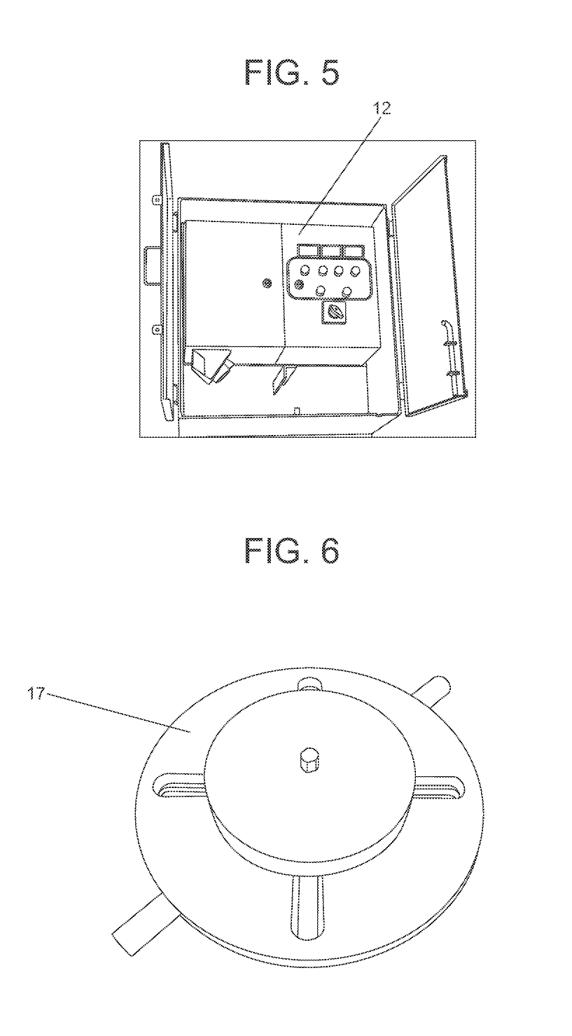

FIG. 5 shows an embodiment of the control panel of the impact generating equipment for dynamic loading tests;

FIG. 6 shows an embodiment of an intermediate element between the adapter and the base of the impact generating equipment for dynamic loading tests;

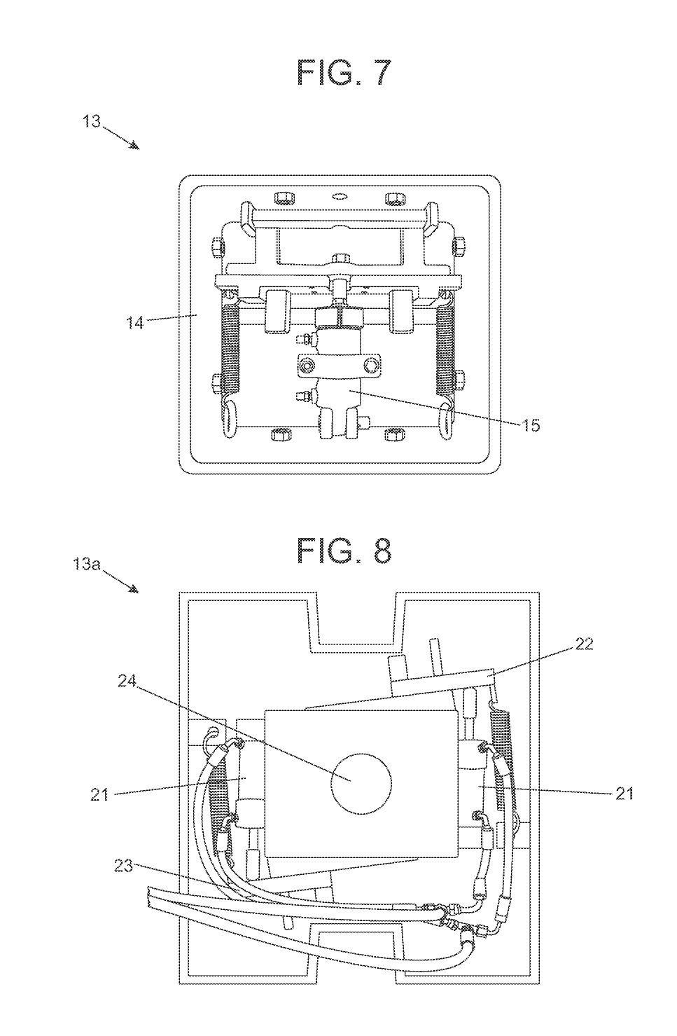

FIG. 7 shows an embodiment of a driving device for the impact hammer; and

FIG. 8 illustrates an embodiment of a constructive variant of the driving device for the impact hammer.

### DETAILED DESCRIPTION

According to the aforementioned drawings, the present invention “IMPACT GENERATING EQUIPMENT FOR DYNAMIC LOADING TESTS” discloses an impact generating equipment 1 for dynamic loading tests, which is basically constituted by a main structure 2 consisting of several distinct elements, namely, a lower base 3 provided with symmetrical side columns 4 and diametrically opposite to each other, which receive, each of them, one hydraulic piston 5, both fixed at lateral fixing supports 6 of an upper external base 7, which, in turn, receives inferiorly an vertical axial axis 8 on which is positioned and slides a hammer 9 sectioned in parts 9a, 9b and 9c, each of them comprising surrounding flanges 10a, 10b and 10c for an eventual attachment between the parts.

The lower portion 3 of the main basis of the equipment 1 also receives a control panel 12 for the actions performed by the same, and a box 13 in which is provided the mechanical structure 14 with a hydraulic piston 15 that allows the activation of the sectioned impact hammer 9.

Another integral part of the impact generating equipment 1 for dynamic loading tests consists of an adapter 16, which is positioned under said equipment 1, particularly between it and the end of the reinforcing block of the pile E to be tested.

Thus, the procedure for the positioning of equipment 1 and later testing, starts by fitting the adapter 16 along the upper face of the reinforcement block of the pile E to be tested, said adapter 16 being provided with a flange 17 which corresponds to the lower face of the main base of this equipment 1, where an impact helmet 18 is positioned with a plate of HDPE (High Density Polyethylene) 19 over it, on which the impact itself will be applied.

Thus, the lower portion of the main base 3 of equipment 1 is called impact helmet 18 and receives on his upper face, as mentioned before, a plate of HDPE 19 with a density equal to or greater than 0.941 g/cm³, with low branching level, high density and high intermolecular forces, being for this reason capable to withstand and properly transmit the loads applied to it, providing a more adequate and accurate test.

The contact area of the hammer 9 on the pile E is defined from 70% to 130% of the cross sectional area of the pile.

This equipment 1 provides a drop height of the hammer 9 of up to two meters and forty centimeters.

The adapter 16 is fitted inferiorly close to the free upper end of the pile E and has an approximate surrounding clearance 20 of one centimeter for adjustment and absorption of any horizontal movements that may occur during the test.

On the upper side, the adapter 16 is fixed to the flange 17 on the lower end face of the main basis of equipment 1, said equipment 1 being by this way fully supported over the upper surface of the reinforcing block of pile E.

Subsequently, with the use of control panel 12, all the adjustments and settings for the execution of the test are configured, and the hydraulic pistons 5 are activated to properly position the impact hammer 9, whether with one, two or three elements, depending on the load requirement.

Depending on the configurations of different piles E used at the same construction site, the same equipment 1 is likely to proceed the tests, being enough a recalculation of the necessary impact energy to know how many parts 9a, 9b or 9c of the sectioned impact hammer 9 will be necessary for the implementation of a second test at the same construction site.

The total weight of the hammer 9 may vary and lies around 30 tons or more, and it can be divided into several parts, whereby these weights are also variable.

As mentioned above, the weights 9a, 9b or 9c of the hammer are variable depending on the need of each test. In the case of using only one hammer 9, the approximate weight may be set from 2 to 30 tons, or more.

The flexibility of use of this equipment 1 is absolutely new and will allow professionals of construction sites to perform tests on piles E of different structures without the need to transport other equipment with appropriate weights and configurations to test a different pile E, greatly minimizing the logistic costs of the construction site and optimizing the entire test, since this equipment 1 provides a substantially higher precision compared to conventional equipment.

A different embodiment for the activation of the hammer 9 considers the use of smaller hydraulic pistons 21 which are moved, and through the pivoting panels 22 and 23, unblock a hole 24 so that the locking element can release the fall of the hammer 9, and in which said elements are properly accommodated in the box 13a.

Although the detailed description of the present invention, it is important to understand that it does not limit its application to the details and steps herein described. The invention is capable of other embodiments and of being practiced or performed in a variety of ways. It should be understood that the terminology used herein was used for description purposes and is not intended to limit the present invention.

1. An impact generating equipment for dynamic loading tests, wherein it consists of an impact generating equipment for dynamic loading tests, which is constituted by a main structure consisting of several distinct elements, namely, a lower base provided with symmetrical side columns and diametrically opposite to each other, which receive, each of them, one hydraulic piston, both fixed at lateral fixing supports of an upper external base, which, in turn, receives inferiorly an vertical axial axis on which is positioned and slides a hammer; the lower portion of the main basis of the equipment also receives a control panel and a box in which is provided a mechanical structure with a hydraulic piston for the activation of the hammer; still another integral part of the impact generating equipment for dynamic loading tests consists of an adapter, which is positioned under said equipment, particularly between it and the end of the reinforcing block of the pile to be tested; the lower portion of the main base of equipment is called impact helmet and receives on his upper face, as mentioned before, a plate of HDPE.

2. The equipment according to claim 1, wherein the procedure for the positioning of equipment and later testing, starts by fitting the adapter along the upper face of the reinforcement block of the pile to be tested, said adapter being provided with a flange which corresponds to the lower face of the main base of this equipment, where the impact helmet is positioned with a plate of HDPE over it, on which the impact is applied.

3. The equipment according to claim 1, wherein the plate of HDPE has a density equal to or greater than 0.941 g/cm³, with low branching level, high density and high intermolecular forces.

4. The equipment according to claim 1, wherein the adapter is fitted inferiorly close to the free upper end of the pile and has an approximate surrounding clearance of one centimeter for the absorption of eventual horizontal movements during the test.

5. The equipment according to claim 1, wherein the adapter is fixed to the flange on the lower end face of the main basis of equipment, the equipment being fully supported over the upper surface of the reinforcing block of pile.

6. The equipment according to claim 1, wherein the total weight limit of the hammer is 30 tons.

7. The equipment according to claim 1, wherein the hammer is sectioned in parts.

8. The equipment according to claim 1, wherein when the hammer consists of a unique element, its weight may vary between 2 and 30 tons.

9. The equipment according to claim 1, wherein it comprises an upper external base, which, in turn, receives inferiorly an vertical axial axis on which is positioned and slides a hammer sectioned in parts.

10. The equipment according to claim 1, wherein each of the parts of the hammer comprise flanges, surrounding and for fixing between the parts.

11. The equipment according to claim 1, wherein the contact area of a hammer for a pile is defined from 70% to 130% of the cross sectional area of the pile.

12. The equipment according to claim 1, wherein the equipment provides a drop height for the hammer of up to two meters and forty centimeters.

13. The equipment according to claim 1, wherein the equipment is positioned and supported only over the upper face of the reinforcing block of the pile to be tested.

14. The equipment according to claim 1 and to a constructive variant, wherein the activation of the hammer considers the use of smaller hydraulic pistons which are moved, and through the pivoting panels, unblock a hole so that the locking element releases the fall of the hammer, and said elements are properly accommodated in the box.
